(19) United States
(12) Patent Application Publication
(10) Pub. No.: US 2020/0166649 A1
(43) Pub. Date: May 28, 2020

(54) ADVERSE WEATHER CONDITION DETECTION SYSTEM WITH LIDAR SENSOR

(71) Applicant: Continental Automotive Systems, Inc., Auburn Hills, MI (US)

(72) Inventor: Nehemia Terefe, Santa Barbara, CA (US)

(73) Assignee: Continental Automotive Systems, Inc., Auburn Hills, MI (US)

(21) Appl. No.: 16/199,455

(22) Filed: Nov. 26, 2018

(51) Int. Cl. G01S 17/95; G01S 17/93; G01S 7/497; G01S 7/481; G01S 17/02; G01S 17/87; G01S 17/89

(52) U.S. Cl. CPC G01S 17/95; G01S 17/936; G01S 7/497; G01S 17/89; G01S 17/023; G01S 17/87; G01S 7/481

(57) ABSTRACT

A method and apparatus detects adverse weather conditions. The method provides a system including a LIDAR sensor having a transmitting portion including a light source and illumination optics, and a receiving portion having a photodetector or photodetector array for receiving reflected light, and receiving optics. The receiving optics is spaced from the illumination optics. The illumination optics and the receiving optics each define a field of view, with the field of views overlapping at a certain distance from the sensor defining a solid object sensing region. A region located outside of the solid object sensing region defines a non-overlapping region. The photodetector determines if a signal exists in the solid object sensing region indicative of a solid object therein. The same photodetector also determines if a signal exists in the non-overlapping region indicative of an adverse weather condition affecting the vehicle.

### FIELD

This invention relates LIDAR (Light Detection and Ranging) systems and, in particular, to High Resolution Flash LIDAR (HFL) sensors that detects adverse conditions such as weather conditions affecting a vehicle as well as detecting solid objects in the field of view.

### BACKGROUND

LIDAR sensors, used in advanced driver assist systems, undergo significant performance degradation in bad weather conditions. These conditions include rainfall, snowfall, hail, drizzle, haze, smog, fog, spray formed by droplets of water kicked up by a tire of a vehicle driving on wet road (freeways), etc. The performance of the sensor degrades due to three main reasons. First, the power of the laser is scattered, significantly reducing the maximum detectable distance. Secondly, the returns from snowflakes, rain drops and fog are confused with returns from solid objects. Thirdly, the quality of the LIDAR image or point cloud decreases due to interference from weather objects. This degradation increases the need to detect the current weather condition in which the vehicle is driving in order to be able to enter into a weather mode where some functionality will be disabled after notifying the driver to take over.

A conventional driver assist system for detecting weather such as rain is disclosed in EP 3091342 A1. This system uses additional channel for bad weather detection as opposed to the technique used in this patent where the normal object detection channel is used both for detection of weather and objects. This state of the art is also limited in the sense that, it probes a very limited space in front of the vehicle making the reliability questionable. In addition, this conventional way of detection is not able to distinguish the type of weather condition such as rain, snow, fog, spray etc., since this channel has a very limited resolution. However, weather detection using the HFL sensor disclosed herein can detect and classify weather conditions reliably owing to its high resolution and fast sampling rate of the lidar signal.

U.S. Pat. No. 8,879,049 discloses an optical sensing system that uses a dedicated photodiode or receiver channel which overlaps with the illumination field only for short distance in front of the sensor. The photodiode cannot be used for any other purpose. This method again suffers from the same problem that it probes a very small region (few cm³) and is unable to classify weather condition due to its very low resolution.

Thus, there is a need to have a robust and cost-effective weather detection and classification system for a driver assist or autonomous vehicles to make them safe and reliable. Hence, this additional feature helps the vehicles to easily monitor their environments and predict/notify performance degradation reliably.

### SUMMARY

An objective of the invention is to fulfill the need referred to above. In accordance with the principles of an embodiment, this objective is achieved by a method of detecting adverse weather conditions in a driver assist or autonomous vehicle system for a vehicle. The method provides a system including a LIDAR sensor (HFL sensor in particular) having a transmitting portion including a light source and illumination optics, and a receiving portion having a photodetector or array of photodetectors as used in HFL sensor, for receiving reflected light, and receiving optics. The receiving optics is spaced from the illumination optics. The illumination optics and the receiving optics each define a field of view, with the field of views overlapping at a certain distance from the sensor defining a solid object sensing region. A region located outside of the solid object sensing region defines a non-overlapping region. The photodetector determines if a signal exists in the solid object sensing region indicative of a solid object therein. The same photodetector also determines if a signal exists in the non-overlapping region indicative of an adverse weather condition affecting the vehicle.

In accordance with another aspect of an embodiment, a system for detecting adverse conditions in an environment includes a LIDAR sensor having a transmitting portion including a light source and illumination optics, and a receiving portion having a photodetector or array of photodetectors as used in HFL sensor, for receiving reflected light, and receiving optics. The receiving optics is spaced from the illumination optics. The illumination optics and the receiving optics each define a field of view, with the field of views overlapping at a certain distance from the sensor defining a solid object sensing region. A region located outside of the solid object sensing region defines a non-overlapping region. The photodetectors are constructed and arranged to detect at least one signal when a solid object is in the solid object sensing region and to detect at least one signal when a non-solid object is in the non-overlapping region. A processor circuit is electrically coupled with the sensor and is constructed and arranged to process signals obtained from the sensor.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of a vehicle equipped with an advanced driver assist or autonomous vehicle system in accordance with an embodiment of the invention.

FIG. 2 is a schematic view of the system of FIG. 1.

FIG. 3 shows an overlap distance for top and bottom pixels of the HFL sensor of FIG. 2.

FIG. 4 shows multiple scattering phenomenon resulting in signals indicative of weather in a non-overlapping region wherein, normally, the HFL sensor is supposed to be blind.

FIG. 5 shows water drops on an optical window, causing a signal in a non-overlapping region.

### DETAILED DESCRIPTION OF EXEMPLARY EMBODIMENTS

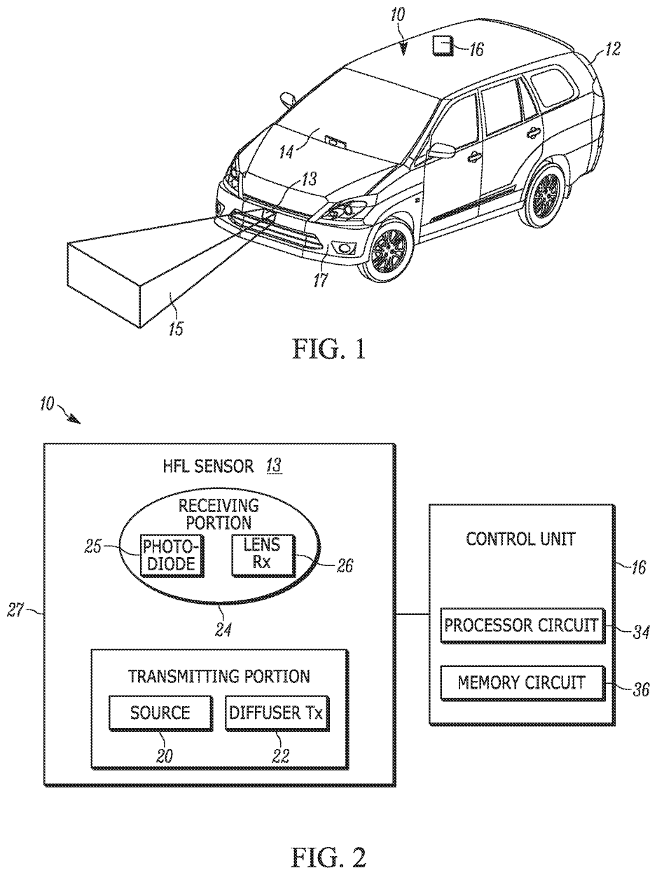

With reference to FIG. 1, an advanced driver assist or autonomous vehicle system is shown generally indicated at 10 for a vehicle 12 in accordance with an embodiment. The system 10 includes a LIDAR sensor 13, preferably, a High Resolution Flash LIDAR (HFL) sensor manufactured by Continental. The sensor 13 is typically on the exterior of the vehicle, for example on the front bumper 17, or the side of the vehicle such as between the doors, or on the rear of the vehicle or any other place in or out of the vehicle so as to illuminate an area outside of the vehicle with laser light 15 and detects the reflection of the laser light from objects disposed in the lighted area. A control unit 16 is coupled to the sensor 13 so as to process signals received from the sensor 13.

With reference to FIG. 2, the HFL sensor 13 includes a transmitting portion 18 including a light source 20 such as a laser diode, solid state laser, gas laser, etc., and illumination optics (Tx) such as a diffuser 22. A receiving portion 24 of the sensor 13 includes a photodetector such as a PIN photodiode or photodetector array 25 for receiving reflected light, and includes a receiving optics (Rx) such as a lens 26. The illumination optics (Tx) is spaced from the receiving optics (Rx) in housing 27.

Unlike normal cameras, the HFL sensor 13 is an active sensor having its own illumination (laser diode 20) with a defined divergence or field of view. Due to mechanical reasons and design requirement, the illumination optics Tx and receiving optics Rx are not located at the same position. As a result, the illumination field of view (FOV) and the receiving field of view do not overlap until some distance in front of the sensor called the “overlapping distance”. The overlapping distance is the distance required for the pixel's FOV to overlap with the illumination field of the radiation (laser). This overlap distance depends on the separation distance between the illumination and receiving optics. The larger the distance between the receiving optics Rx and illumination optics Tx, the larger is the overlap distance. Moreover, since the detector array 25 of the HFL sensor 13 has multiple pixels (thousands), each of these pixels have their own overlap distance given by their position on the focal plane array (FPA).

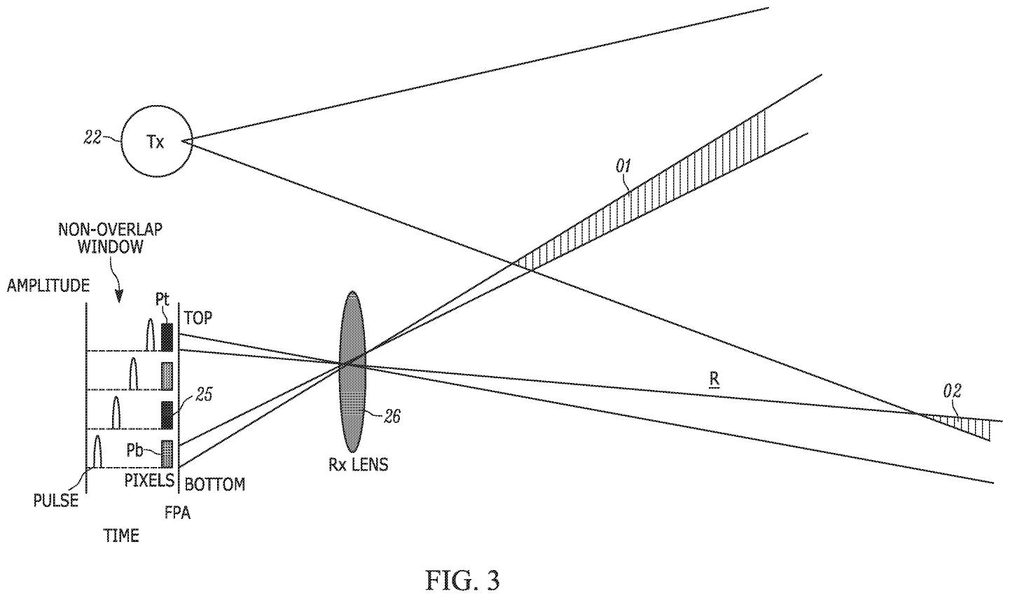

With reference to FIG. 3, in this particular embodiment, the illumination optics or diffuser 22 is located above the receiving optics or lens 26. The pixel (Pt) located at the top part of the FPA looks down while the pixel (Pb) located at the bottom looks up. Due to this configuration, the bottom pixel overlaps with illumination earlier than the top pixel. The hatched areas O1, O2 indicate the region where the pixel's Filed of View (FOV) (through the lens 26) and the illumination optics 22 FOV overlap or intersect, with these regions defining solid object sensing regions. Prior to or outside of this intersection, the pixel of the detector array 25 is not able to see any solid object (non-diffuse object). This is referred to as a “non-overlapping region” R or “blind window”.

However, due to special optical phenomena, e.g., multiple scattering from fog, spray, rain, snow, or other non-solid objects, the photodiode or detector array 25 can detect a signal in the blind window. Hence, the presence of this signal in the non-overlapping region R serves as a fingerprint for the presence of adverse weather condition (snow, spray, fog, etc.). This non-overlap region R is few centimeters to meters depending on the distance between the Illuminating optics and the receiving optics and the location of the pixel on the FPA. Edge pixels normally have longer overlapping distance.

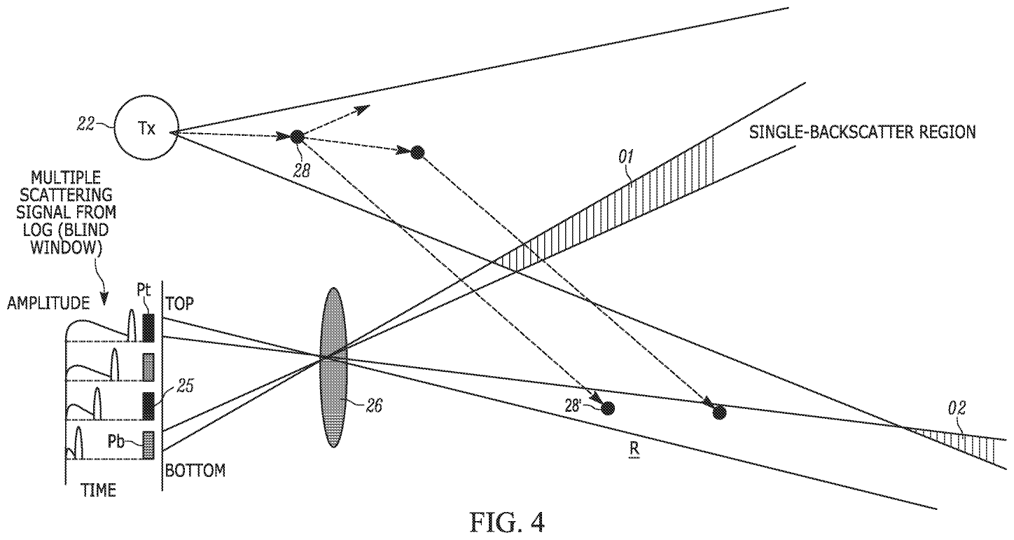

FIG. 4 shows multiple scattering phenomenon where light first bounces off from weather particles 28 such as fog particles, spray particles, rain drops, and snowflakes and then gets scattered by the second particle 28′ in the pixel's field of view. This multi-scattering phenomenon is highly likely when the number of particles is high as in case of fog, spray or heavy rain. This phenomenon also leads to the photodiode or detector array 25 detecting a signal in the non-overlap region R, indicating the presence of adverse weather condition.

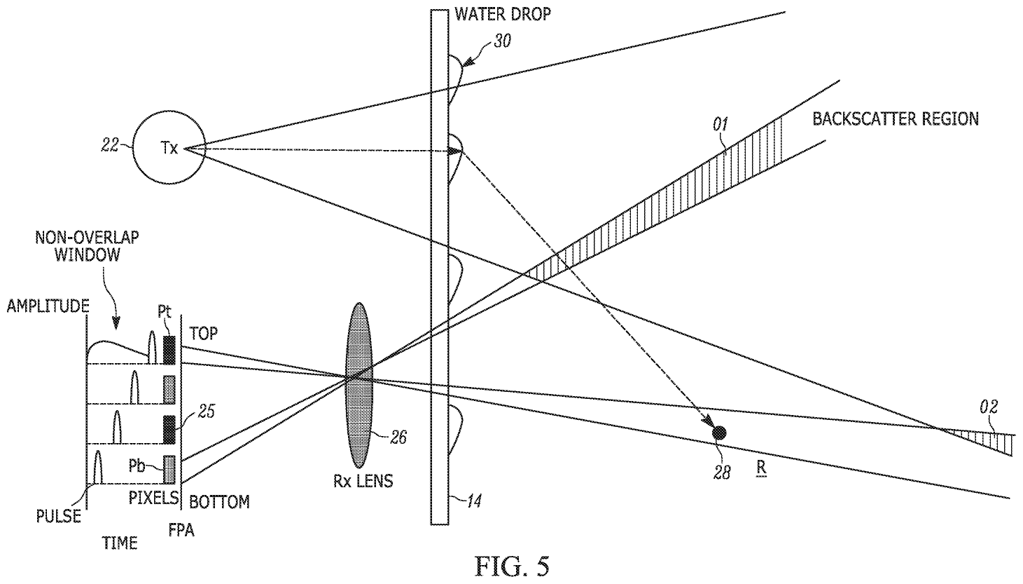

In addition, with reference to FIG. 5, a signal in the non-overlapping region R can be caused when water drops 30 from spray, rain or fog get deposited on the optical window 14. In this case, the drops 30 on the optical window 14 distort the illumination field causing over-illumination. As shown in FIG. 5, this creates a signal in non-overlapping region R, serving as a fingerprint for the presence of adverse weather condition.

As used herein “fog particles” are little droplets of water suspended in air usually in the range of few microns of meters. “Spray” is a fog-like material produced when a car drives over a wet road. This is formed when the water on the ground is kicked up by the tire of a vehicle forming cloud of little droplets of water in the air. The size of spray droplet is usually bigger than fog droplets and is highly dynamic behavior because of air turbulence from the vehicle. This is usually formed at high speeds on highways. “Scattering”, in simple terms, is a phenomenon where a light incident on a particle is scattered in all directions (usually in varying degrees). Depending on the size of the particle relative to the wavelength of the incident light the scattering behavior changes. In the emission wavelength of the laser of the HFL sensor 14, the fog particles interact with light in what is referred to as “Mie Scattering”. This scattering is more omni-directional for small size particles while it is more forward scattered for larger particles.

In accordance with the embodiment, after detection of the weather condition by detecting a signal in the non-overlapping region noted above, an algorithm is executed by a processor circuit 34 of the control unit 16 (FIG. 2) which filters out the weather effect from the data of the HFL sensor 13 or labels the points in point cloud data to distinguish if they are real objects or weather related objects (snowflake, raindrop, spray etc.). Memory circuit 36 stores sensor data.

Returning to FIG. 2, a key parameter which increases the non-overlapping distance is the distance between the Tx optics 22 and the Rx optics 26. This could be achieved by increasing the separation between the Tx and Rx optics horizontally or vertically or both. As shown, displacing the Tx optics 22 and the Rx optics 26 both vertically and horizontally as much as possible is preferable for weather detection. However, increasing the separation between the Rx optics 26 and the Tx optics 22 reduces the smallest distance one is able to measure. Thus, a balance is used to set this distance between the Rx and Tx optics.

Generally, a slight separation of the Tx optics 22 and the Rx optics 26 path in the direction of low beam divergence (could be horizontal or vertical) produces a larger overlapping distance. Thus, a larger separation of the Rx and Tx optics is preferred in the direction of low divergence of the illumination.

The operations and algorithms described herein can be implemented as executable code within a micro-controller or control unit 16 having processor circuit 34 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 36 can be implemented, for example, using a non-volatile memory such as a programmable read only memory (PROM) or an EPROM, and/or a volatile memory such as a DRAM, etc.

Advantages of the system 10 of the embodiment include:
better reliability of weather detection as the non-overlapping signal is available on many pixels. This eliminates the chances of false weather detection due to noise,
more sensitive for detecting weather related particles as the pixels are close to the laser illumination,
doesn't require additional hardware,
the same pixel array or photodiode 25 used for weather detection is used for solid object detection in the overlapping region,
easy implementation,
implementation is well specialized for high resolution LIDAR,
image processing can be applied by the processor circuit 34 on non-overlapping signal as it is available on many pixels,
image processing on the non-overlapping signal can distinguish between precipitating (rain, snow) and non-precipitating (fog, spray) weather,
eliminates the need for additional dedicated photodiode or receiver channel which looks outside of the illumination field,
is more sensitive for weather detection as it has finite overlap distance,
a signal is theoretically available in almost all pixels which increases the reliability of the weather detection unlike a dedicated single or few pixels and averaging the pre-overlap signal over multiple pixels gives reliable weather detection.

Although the above described system and method has been disclosed to detect an adverse weather condition, other methods using the HFL sensor 13 can be employed. For example, another method includes processing of clusters at close distance. Rain and snow have small clusters, round shape, are not persistent. Intensity and reflectivity can also be considered. Fog and spray have big clusters, have a shape of FOV, are persistent and transparent. Other methods can include processing of point cloud, monitoring overlap of clusters, post ground etc., or monitoring multiple pulse detections.

Although the embodiment has been disclosed for use in a driver assist system or autonomous vehicle system, the system 10 can be used in other adverse environments, such as for detection in dusty or smoke-filled environments. In addition the system 10 can be used as weather sensor for meteorological applications.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A method of detecting weather conditions, the method comprising:
providing in the system, a LIDAR sensor having a transmitting portion including a light source and illumination optics, and a receiving portion having at least one photodetector, for receiving reflected light, and receiving optics, the receiving optics being spaced from the illumination optics, the illumination optics and the receiving optics each defining a field of view, with the field of views overlapping at a certain distance from the sensor defining a solid object sensing region, with a region located outside of the solid object sensing region defining a non-overlapping region,
determining, by the at least one photodetector, if a signal exists in the solid object sensing region indicative of a solid object therein, and
determining, by the same at least one photodetector, if a signal exists in the non-overlapping region indicative of an weather condition.

2. The method of claim 1, wherein the weather condition is one of rainfall, snowfall, hail, drizzle, haze, smog, fog, and spray formed by droplets of water.

3. The method of claim 1, wherein the system includes a processor circuit and wherein, if a signal exists in the non-overlapping region, the method further comprises:
using the processor circuit to filter out the weather condition from data obtained by the sensor.

4. The method of claim 1, wherein the step of providing the sensor includes spacing the transmitting optics horizontally, vertically or both vertically and horizontally from the receiving optics within a housing of the sensor.

5. The method of claim 1, wherein the sensor is provided as a high-resolution flash LIDAR sensor.

6. The method of claim 1, wherein said at least one photodetector comprises a single photo detector or a photodetector array having a plurality of pixels on a focal plane array, with each pixel defining a field of view that overlaps with the field of view defined by the illumination optics at a certain distance from the sensor, defining the solid object sensing region.

7. The method of claim 6, further comprising averaging existing signals in the non-overlapping region over multiple said pixels.

8. The method of claim 1, wherein the system includes a processor circuit and wherein, if a signal exists in the non-overlapping region, the method further comprises:
using the processor circuit to determine a type of the weather condition as one of rainfall, snowfall, hail, drizzle, haze, smog, fog, and spray formed by droplets of water.

9. The method of claim 1, wherein the system includes a processor circuit and wherein, if a signal exists in the non-overlapping region, the method further comprises:
using the processor circuit to perform image processing on a signal existing in the non-overlapping region to distinguish between precipitating and non-precipitating weather conditions.

10. The method of claim 5, further comprising mounting the sensor on a vehicle as part of an advanced driver assist or autonomous vehicle system.

11. A system for detecting adverse conditions in an environment, the system comprising:
a LIDAR sensor having a transmitting portion including a light source and illumination optics, and a receiving portion having at least one photodetector for receiving reflected light, and receiving optics, the receiving optics being spaced from the illumination optics, the illumination optics and the receiving optics each defining a field of view, with the field of views overlapping at a certain distance from the sensor defining a solid object sensing region, with a region located outside of the solid object sensing region defining a non-overlapping region, the photodetector being constructed and arranged to detect at least one signal when a solid object is in the solid object sensing region and to detect at least one signal when a non-solid object is in the non-overlapping region, and
a processor circuit electrically coupled with the sensor and constructed and arranged to process signals obtained from the sensor.

12. The system of claim 11, wherein the processor circuit is constructed and arranged to filter out the detected non-solid object signal from data of the sensor.

13. The system of claim 11, wherein the processor circuit is constructed and arranged determine the type of non-solid object detected.

14. The system of claim 11, wherein the illumination optics is spaced vertically, horizontally or both vertically and horizontally from the receiving optics within a housing of the sensor.

15. The system of claim 14, wherein the illumination optics includes a diffuser and the receiving optics includes a lens.

16. The system of claim 11, wherein the sensor is provided as a high-resolution flash LIDAR sensor.

17. The system of claim 11, wherein said at least one photodetector comprises a single photodetector or a photodetector array having a plurality of pixels on a focal plane array, with each pixel having field of view that overlaps with the field of view defined by the illumination optics at a certain distance from the sensor, defining the solid object sensing region.

18. The system of claim 17, wherein the processor circuit is constructed and arranged to average signals in the non-overlapping region over multiple said pixels.

19. The system of claim 16, in combination with a vehicle, wherein the detected non-solid object is an adverse weather condition affecting the vehicle and the processor circuit is constructed and arranged to determine a type of the weather condition as one of rainfall, snowfall, hail, drizzle, haze, smog, fog, and spray formed by droplets of water.

20. The system of claim 19, wherein the processor circuit is constructed arranged to perform image processing on the signal obtained when the non-solid object is detected in the non-overlapping region so as to distinguish between precipitating and non-precipitating weather conditions.
